(19) United States
(12) Patent Application Publication
(10) Pub. No.: US 2024/0191075 A1
(43) Pub. Date: Jun. 13, 2024

(54) FLAME RETARDANT POLYAMIDE COMPOSITIONS

(71) Applicant: Ascend Performance Materials Operations LLC, Houston, TX (US)

(72) Inventor: Kimberly M. White, Houston, TX (US)

(73) Assignee: Ascend Performance Materials Operations LLC, Houston, TX (US)

(21) Appl. No.: 18/523,012

(22) Filed: Nov. 29, 2023

Related U.S. Application Data
(60) Provisional application No. 63/385,545, filed on Nov. 30, 2022.
(60) Provisional application No. 63/387,494, filed on Dec. 14, 2022.

(51) Int. Cl. C08L 77/06

(52) U.S. Cl. CPC C08L 77/06; C08L 2205/035

(57) ABSTRACT

A flame retardant polyamide composition comprising a synergistic combination of an epoxy-terminated brominated epoxy polymer with a tribromophenol end-capped brominated epoxy polymer. The polyamide compositions have excellent resistance to heat and good elongation-at-break properties without the presence of decabromodiphenyl ethane.

### CROSS-REFERENCE

This application claims priority to U.S. Provisional Application No. 63/385,545, filed Nov. 30, 2022, and U.S. Provisional Application No. 63/387,494, filed Dec. 14, 2022, both of which are incorporated by reference in their entirety.

### FIELD

The present disclosure relates to flame retardant polyamide compositions and molded products therefrom. More specifically, the present disclosure relates to flame retardant polyamide compositions comprising a synergistic combination of an epoxy-terminated brominated epoxy polymer with a tribromophenol end-capped brominated epoxy polymer that produce polyamide compositions having excellent resistance to heat.

### BACKGROUND

Decabromodiphenyl ethane (DBDPE) is a known flame retardant that, when combined with other components in polyamide compositions, provides good flame-retardant properties, such as good resistance to heat. When used in molding compositions, DBDPE can also provide sufficient elongation-at-break properties.

However, DBDPE has recently been scrutinized for its potential hazardous properties, especially those that may be harmful to organisms in the environment. Although degradation of DBDPE in the environment is expected to be slow, certain studies have shown that it may transform into substances that would be persistent, bioaccumulative in some cases, and potentially highly toxic to aquatic organisms. Because of these findings, certain countries, including Canada, are looking at banning the use of DBDPE in various chemical compositions including plastic and rubber materials, electrical and electronic equipment, and adhesives and sealants.

There therefore exists a need in the art for flame retardant polyamide composition that provides beneficial flame retardant properties (and optionally mechanical properties) while reducing or eliminating the hazardous properties that have led to DBDPE's regulatory scrutiny. This disclosure answers that need.

### SUMMARY

In some embodiments, the present disclosure is directed to a flame retardant polyamide composition comprising: from 50 wt % to 75 wt % of a polyamide, such as PA6,6 or PA6; less than 18 wt % (or completely free) of DBDPE; from 12.1 wt % to 15.9 wt % (such as 13-15 wt %) of an epoxy-terminated brominated epoxy polymer; from 8.1 wt % to 11.9 wt % (such as 9-11 wt %) of a tribromophenol end-capped brominated epoxy polymer; and either (a) from 1 wt % to 10 wt % of two or more plasticizers, or (b) from 1 wt % to 5% of one or more plasticizers and from 1 wt % to 5 wt % of one or more flame retardant synergists. The polyamide composition demonstrates an elongation of break of at least 9%, or at least 12%; and a UL-94 rating of V-2, or at least V-1, or better.

In some embodiments, the present disclosure is directed to a flame retardant polyamide composition comprising: from 50 wt % to 75 wt % of a polyamide, such as PA6,6 or PA6; less than 18 wt % (or completely free) of DBDPE; from 11 wt % to 16 wt % of one or more compounds selected from the group consisting of epoxy-terminated brominated epoxy polymers and brominated polystyrene compounds; from 8 wt % to 13 wt % of a tribromophenol end-capped brominated epoxy polymer; and from 1 wt % to 10 wt % of one or more plasticizers. The polyamide composition demonstrates an elongation of break of at least 9%, or at least 12%; and a UL-94 rating of V-2, or at least V-1, or better.

In some embodiments, the present disclosure is directed to a flame retardant polyamide composition comprising: from 50 wt % to 75 wt % of a polyamide, such as PA6,6 or PA6; less than 18 wt % (or completely free) of DBDPE; from 10 wt % to 18 wt % (such as 12-16 wt %) of an epoxy-terminated brominated epoxy polymer; from 6 wt % to 14 wt % (such as 8-12 wt %) of a tribromophenol end-capped brominated epoxy polymer; from 3.5 wt % to 10 wt % (such as 3.5-5 wt %) antimony trioxide; and (a) from 1 wt % to 5 wt % diundecyl phthalate plasticizer, and from 1 wt % to 5 wt % of triethylene glycol bis(2-ethylhexanoate) plasticizer, or (b) from 2.5 wt % to 5 wt % diundecyl phthalate plasticizer. The polyamide composition demonstrates an elongation of break of at least 8% (or at least 9%); and a UL-94 rating of V-0, which may be measured at 0.4 mm, 0.75 mm, 1.5 mm, and 3.0 mm.

In some embodiments, the present disclosure is directed to a molded flame retardant polyamide product according to any one of the polyamide compositions described herein.

### DETAILED DESCRIPTION

As noted above, there are environmental concerns associated with the use of traditional flame retardants, e.g., DBDPE, in many polymer applications, e.g. molding applications. As a result, polyamide compositions having lower amounts, or no DBDPE at all, are desired. Other flame retardants and flame retardant packages are also known. However, these conventional packages often demonstrate poor performance in terms of flame retardancy and/or poor mechanical performance.

The inventors of this application have surprisingly found that using the disclosed flame retardant packages, e.g., those comprising two types of polymers optionally at specific weight percentages, provide for a synergistic combination of performance benefits, e.g., flame retardant and/or mechanical properties. For example, the disclosed compositions have been found to demonstrate flame retardant properties that were otherwise achieved by DBDPE along with suitable mechanical properties, e.g., elongation-at-break. Specifically, the inventors have unexpectedly found that polyamide compositions containing from 12.1 wt % to 15.9 wt %, or from 10 wt % to 18 wt %, of an epoxy-terminated brominated epoxy polymer, and from 8.1 wt % to 11.9 wt %, or from 6 wt % to 14 wt %, of a tribromophenol end-capped brominated epoxy polymer synergistically provide the desired flame-retardant and elongation-at-break properties.

In some embodiments, the flame-retardant properties can be even further improved, for instance having at least one UL-94 rating of V-0, when the polymers are combined with either (a) from 1 wt % to 10 wt % of two or more plasticizers, or (b) from 1 wt % to 5% of one or more plasticizers and from 1 wt % to 5 wt % of one or more flame retardant synergists. In other embodiments, the flame-retardant properties can be even further improved, for instance having a UL-94 rating of V-0, when the polymers are combined with 3.5 wt % to 10 wt % antimony trioxide and either (a) from 1 wt % to 5 wt % diundecyl phthalate plasticizer, and from 1 wt % to 5 wt % of triethylene glycol bis(2-ethylhexanoate) plasticizer, or (b) from 2.5 wt % to 5 wt % diundecyl phthalate plasticizer. It is this unique combination of plasticizers and flame retardant synergists at particular amounts that provides the synergy and unexpected results relating to the improved flame-retardant properties.

Without being bound be theory, it is believed that the disclosed combinations of flame retardants, when employed in a polymer composition, act to provide a unique combination of efficiencies good physical properties associated with halogenated polymer compounds. In contrast, conventional polymer compositions employ different compounds and/or use compounds in differing amounts, which do not provide the aforementioned combination of performance benefits.

In some embodiments, the present disclosure is directed to a flame retardant polyamide composition comprising: a polyamide; low amounts if any, e.g., less than 18 wt %, of a DBDPE flame retardant; along with an epoxy-terminated brominated epoxy polymer and a tribromophenol end-capped brominated epoxy polymer. The synergistic combination of these components, optionally employed in the concentrations disclosed herein, provides for a polyamide composition that demonstrates an elongation of break of at least 8%, or at least 9%, and a UL-94 rating of V-2 or better, such as V-0. The polyamide composition may comprise other components as well, e.g., (from 1 wt % to 10 wt % of) one or more plasticizers and/or antioxidants and/or stabilizers.

In some cases, the flame retardant polyamide composition comprises the epoxy-terminated brominated epoxy polymer in an amount ranging from 8 wt % to 20 wt %, or from 6 wt % to 14 wt %, and/or the tribromophenol end-capped brominated epoxy polymer in an amount ranging from 4 wt % to 16 wt %, or from 6 wt % to 14 wt %. This combination works synergistically to provide for the combination of performance features. These and other components of the composition and the concentrations thereof are discussed in more detail below.

In some embodiments, the tribromophenol end-capped brominated epoxy polymer component can be utilized with one or more brominated polystyrene compounds. Thus, in this embodiment, the present disclosure is directed to a flame retardant polyamide composition comprising: a polyamide; low amounts if any of DBDPE; from 8 wt % to 13 wt % the tribromophenol end-capped brominated epoxy polymer and/or brominated polystyrene compounds; and optionally the epoxy-terminated brominated epoxy polymer and/or the plasticizers. The polyamide composition demonstrates the combination of performance features.

### Epoxy-Terminated Brominated Epoxy Polymer

The flame retardant polyamide composition contains the epoxy-terminated brominated epoxy polymer. Suitable epoxy-terminated brominated epoxy polymers include any brominated epoxy polymer known to one skill in the art that contains one or more bromine functional groups and is end capped or terminated with one or more epoxy groups.

The epoxy-terminated brominated epoxy polymer may be an epoxy-terminated, tetrabromobisphenol-A brominated epoxy polymer. Alternatively, the epoxy-terminated brominated epoxy polymer may be a compound of Formula I:

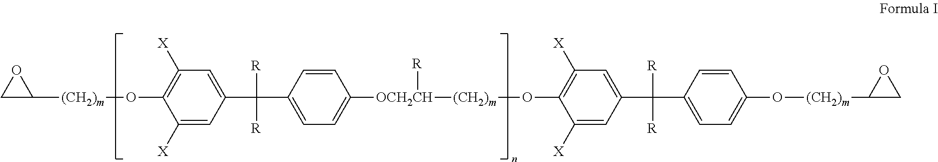

wherein each X is independently Br or H, provided that at least one X is Br; each R is independently H or a C₁-C₄ alkyl group; each m is an integer from 1-4; and n is an integer ranging from 10 to 75. In some embodiments, each X is Br, each R is methyl, and each m is 1.

The amount of bromine in the epoxy-terminated brominated epoxy polymer can vary according to the desired level. In some embodiments, the epoxy-terminated brominated epoxy polymer contains at least 30% wt % bromine, at least 40 wt % bromine, at least 50 wt % bromine, at least 52 wt % bromine, at least 54 wt % bromine, or at least 55 wt % bromine.

One or more of the epoxy-terminated brominated epoxy polymers may have a molecular weight ranging from 15,000 to 35,000. For instance, the molecular weight of the epoxy-terminated brominated epoxy polymer may range from 20,000 to 30,000; or from 22,500 to 27,500; or may be about 25,000. Other epoxy-terminated brominated epoxy polymers may have a molecular weight ranging from 30,000 to 70,000, e.g., from 35,000 to 65,000; from 40,000 to 60,000; from 45,000 to 55,000; or about 50,000. In one embodiment, the epoxy-terminated-brominated-epoxy-polymer component may contain one or more polymers falling within each of the molecular-weight ranges.

In some cases, the polyamide composition comprises the epoxy-terminated brominated epoxy polymer in an amount ranging from 8 wt % to 20 wt %, e.g., from 10 wt % to 18 wt %, from 11 wt % to 17 wt %, from 11 wt % to 16 wt %, from 12 wt % to 16 wt %, from 12.1 wt % to 15.9 wt %, from 12.5 wt % to 15.4 wt %, from 12 wt % to 15 wt %, or from 13 wt % to 15 wt %, or about 14 wt %. In terms of lower limits, the polyamide composition may comprise the epoxy-terminated brominated epoxy polymer in an amount greater than 8 wt %, e.g., greater than 10 wt %, greater than 11 wt %, greater than 12 wt %, greater than 12.1 wt %, greater than 12.5 wt %, greater than 13 wt %, or greater than 14 wt %. In terms of upper limits, the polyamide composition may comprise the epoxy-terminated brominated epoxy polymer in an amount less than 20 wt %, e.g., less than 18 wt %, less than 17 wt %, less than 16 wt %, less than 15.9 wt %, less than 15.4 wt %, less than 15 wt %, or less than 14 wt %.

Representative epoxy-terminated brominated epoxy polymers include F-2400 and F-2100H, both of which are commercially available from ICL-IP.

### Tribromophenol End-Capped Brominated Epoxy Polymer

The flame retardant polyamide composition contains the tribromophenol end-capped brominated epoxy polymer. Suitable tribromophenol end-capped brominated epoxy polymers include any brominated epoxy polymer known to one skill in the art that contains one or more bromine functional groups and is end capped with tribromophenol groups.

The tribromophenol end-capped brominated epoxy polymer may be a tribromophenol end-capped tetrabromobisphenol-A brominated epoxy polymer. Alternatively, the tribromophenol end-capped brominated epoxy polymer may be a compound of Formula II:

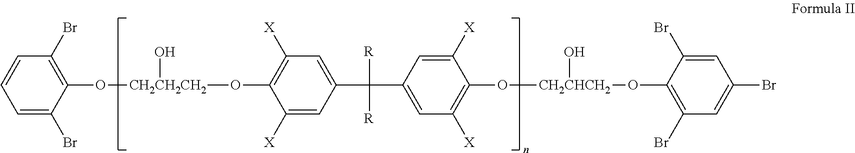

wherein each X is independently Br or H, provided that at least one X is Br; each R is independently H or a C1-C4 alkyl group; and n is an integer ranging from 5 to 25. In some embodiments, each X is Br, and each R is methyl.

The amount of bromine in the tribromophenol end-capped brominated epoxy polymer can vary according to the desired level. In some embodiments, the tribromophenol end-capped brominated epoxy polymer contains at least 40 wt % bromine, at least 50 wt % bromine, at least 55 wt % bromine, at least 60 wt % bromine, or at least 65 wt % bromine.

The tribromophenol end-capped brominated epoxy polymer has a molecular weight ranging from 10,000 to 20,000, or from 12,000 to 18,000, or about 15,000.

In some cases, the polyamide composition comprises the tribromophenol end-capped brominated epoxy polymer in an amount ranging from 4 wt % to 16 wt %, e.g., from 6 wt % to 14 wt %, from 8 wt % to 13 wt %, from 8 wt % to 12, from 8.1 wt % to 11.9 wt %, from 8.5 wt % to 11.4 wt %, from 9 wt % to 12 wt %, from 9 wt % to 11 wt %, or about 10 wt %. In terms of lower limits, the polyamide composition may comprise the tribromophenol end-capped brominated epoxy polymer in an amount greater than 4 wt %, e.g., greater than 6 wt %, greater than 8 wt %, greater than 8.1 wt %, greater than 8.5 wt %, greater than 9 wt %, or greater than 10 wt %. In terms of upper limits, the polyamide composition may comprise the tribromophenol end-capped brominated epoxy polymer in an amount less than 16 wt %, e.g., less than 14 wt %, less than 13 wt %, less than 12 wt %, less than 11.4 wt %, less than 11.1 wt %, less than 11 wt %, or less than 10 wt %.

Representative tribromophenol end-capped brominated epoxy polymers include F-3100, commercially available from ICL-IP.

### Brominated Polystyrene Compounds

The flame retardant polyamide composition may also contain one or more brominated polystyrene compounds. In some embodiments, the brominated polystyrene compounds may be used together with, or in lieu of, the epoxy-terminated brominated epoxy polymers. In these cases, the brominated polystyrene compounds and/or the epoxy-terminated brominated epoxy polymers together will be present in amounts ranging from 11 wt % to 16 wt % and the tribromophenol end-capped brominated epoxy polymer will be present in its 8-13 wt % range. In other embodiments, the epoxy-terminated brominated epoxy polymers and tribromophenol end-capped brominated epoxy polymer will each be present in their 11-16 wt % and 8-13 wt % ranges, respectively, and the brominated polystyrene compounds will present as additional components at lower weigh percentages.

In some cases, the polyamide composition comprises the brominated polystyrene compounds in an amount ranging from 1 wt % to 10 wt %, e.g., from 1 wt % to 5 wt %, from 2 wt % to 8 wt %, from 2 wt % to 10 wt %, or from 5 wt % to 10 wt %. In terms of lower limits, the polyamide composition may comprise the brominated polystyrene compounds in an amount greater than 1 wt %, greater than 2 wt %, greater than 5 wt %, or greater than 10 wt %. In terms of upper limits, the polyamide composition may comprise the brominated polystyrene compounds in an amount less than 10 wt %, less than 8 wt %, less than 5 wt % or less than 2 wt %.

Suitable brominated polystyrene compounds include any polystyrene compounds known to one skill in the art that contain at least one bromine functional group. Representative brominated polystyrene compounds include BPS-64HW, a homopolymer of dibromostyrene commercially available from Lanxess, and HP-3010 or HP-7010, brominated polystyrene products commercially available from Albemarle.

### DBDPE

The flame retardant composition contains low amounts of DBDPE. As noted above, DBDPE has recently been scrutinized for its potential hazardous properties, especially those that may be harmful to organisms in the environment, and certain countries are looking at banning the use of DBDPE in various chemical compositions. Therefore, one of the objectives of this disclosure involves producing an effective flame retardant compositions that advantageously contains lower amounts of DBDPE, or no DBDPE at all,

In some cases, the polyamide composition comprises DPDPE in an amount ranging from 0 wt % to 18 wt %, e.g., from 1 wt % to 15 wt %, from 2 wt % to 10 wt %, or from 1 wt % to 10 wt %. In terms of upper limits, the polyamide composition may comprise DPDPE in an amount less than 18 wt %, e.g., 15% DBDPE, less than 10% DBDPE, less than 5% DBDPE, less than 1% DBDPE, or having no DBDPE at all, i.e. a flame-retardant composition that is free of DBPDE.

### Polyamide

The polyamide component may include varieties of natural and artificial polyamides. Common polyamides include nylons and aramids.

For example, the polyamide may comprise PA-4T/41; PA-4T/6I; PA-5T/51; PA-6; PA-6,6; PA-6,6/6; long chain polyamide (such as PA-10; PA-12; PA-6,10; PA-6,12, as well as other known long chain variants optionally including aromatic components, e.g., T or I components); PA-6,6/6I, PA-6,6/6T; PA-6T/6I; PA-6T/61/6; PA-6T/61/6; PA-6T/61/66; PA-6T/MPMDT; PA-6T/66; PA-6T/610; PA-10T/612; PA-10T/106; PA-6T/612; PA-6T/10T; PA-6T/10I; PA-9T; PA-10T; PA-12T; PA-10T/10I; PA-10T/12; PA-10T/11; PA-6T/9T; PA-6T/12T; PA-6T/10T/6I; PA-6T/61/6; PA-6T/61/12; and copolymers, blends, mixtures and/or other combinations thereof. When desirable, high-temperature polyamides, such as PA6T/66 or PA6TDT, may be used. Additional suitable polyamides, additives, and other components are disclosed in U.S. patent application Ser. No. 16/003,528. MPMDT is polyamide based on a mixture of hexamethylene diamine and 2-methylpentamethylene diamine as the diamine component and terephthalic acid as the diacid component.

The polymer composition may also comprise polyamides produced through the ring-opening polymerization or polycondensation, including the copolymerization and/or copolycondensation, of lactams. Without being bound by theory, these polyamides may include, for example, those produced from propriolactam, butyrolactam, valerolactam, and caprolactam. For example, in some embodiments, the polyamide is a polymer derived from the polymerization of caprolactam.

For example, the polyamide can include aliphatic polyamides such as polymeric E-caprolactam (PA6) and polyhexamethylene adipamide (PA66) or other aliphatic nylons, including polyamides with aliphatic and/or aromatic components. As used herein, the terms “PA6 polymer” and “PA6 polyamide polymer” also include copolymers in which PA6 is the major component. As used herein the terms “PA66 polymer” and “PA66 polyamide polymer” also include copolymers in which PA66 is the major component. In some cases, physical blends, e.g., melt blends, of these polymers are contemplated. In one embodiment, the polyamide polymer comprises PA6,6; PA6; PA610; PA611; PA612; PA10; PA11; PA12, or a combination thereof. Illustrative copolymers of these polyamides include PA6,6/6; PA6,6/610; PA6,6/611; PA6,6/612; PA6,6/10; PA6,6/11; PA6,6/12; PA6/6,6; PA6/610; PA6/611; PA6/612; PA6/10; PA6/11; and PA6/12.

As used herein, the terms “PA66,” “nylon 66,” and “polyamide 66” refer to a homopolymer prepared from hexamethylene diamine and adipic acid monomer subunits. A PA66 polyamide may be a polyamide that contains a significant portion of PA66 units in the polymer backbone, e.g., at least 5 wt %, at least 10 wt %, at least 20 wt %, at least 30 wt %, at least 40 wt %, at least 50 wt %, at least 60 wt %, at least 70 wt %, at least 8-0 wt % or at least 90 wt. As used herein, the terms “PA6,” “nylon 6,” and “polyamide 6” refer to a homopolymer prepared from caprolactam monomer subunits. As used herein, the terms “PA66/6,” “nylon 66/6,” and “polyamide 66/6” refer to a copolymer prepared from hexamethylene diamine and adipic acid monomer subunits and also incorporating caprolactam monomer subunits.

The polyamide may be a copolymer or a homopolymer. For example, the polyamide may be copolymer of PA6 and PA6,6, a PA6 homopolymer or a PA6,6 homopolymer. Other embodiments include nylon derivatives, copolymers, terpolymers, blends and alloys containing or prepared from PA6,6 or PA6.

In some embodiments, the amount of the polyamide, for instance the PA6,6 homopolymer, is present in the polyamide composition at ranges from 35 wt % to 75 wt %, e.g., from 40 wt % to 70 wt %, from 50 wt % to 65 wt %, from 50 wt % to 60 wt %, from 60 wt % to 75 wt %, from 60 wt % to 70 wt %, or from 65 wt % to 75 wt %. In terms of upper limits, the polyamide can be present in amounts less than 75 wt %, e.g., less than 70 wt %, less than 65%, or less than 60 wt %. In terms of lower limits, the first polyamide can be present in amounts greater than 50 wt %, e.g., greater than 60 wt %, greater than 65 wt %, or greater than 70 wt %.

In other embodiments, the polyamide may be an amine-functionalized amide polymer or an amide polymer having a low amine end group (AEG) level, for example a AEG level less than 54 μeq/gram. As used herein, amine end groups are defined as the quantity of amine ends (−NH₂) present in a polyamide. AEG calculation methods are well known.

The disclosed amide polymers utilize particular ranges and/or limits of AEG levels. In some embodiments, the amide polymer has an AEG level ranging from 34 μeq/gram to 54 μeq/gram, e.g., from 40 μeq/gram to 54 μeq/gram, from 42 μeq/gram to 51 μeq/gram, from 42 μeq/gram to 48 μeq/gram, or from 42 μeq/gram to 46.

In terms of lower limits, the base polyamide composition may have an AEG level greater than 34 μeq/gram, e.g., greater than 36 μeq/gram, greater than 38 μeq/gram, greater than 40 μeq/gram, greater than 42 μeq/gram, greater than 44 μeq/gram, greater than 46 μeq/gram, greater than 48 μeq/gram, greater than 50 μeq/gram, or greater than 51 μeq/gram. In terms of upper limits, the base polyamide composition may have an AEG level less than 51 μeq/gram, e.g. less than 50 μeq/gram, less than 48 μeq/gram, less than 46 μeq/gram, less than 44 μeq/gram, less than 42 μeq/gram, less than 40 μeq/gram, less than 38 μeq/gram, less than 36 μeq/gram, or less than 34 μeq/gram.

The utilization of the specific AEG levels provides for the unexpected combination of reduced reactivity during compounding and molding and higher flow resultant compounds. Higher reactivity produces desired high elongation at break, but it is also helping in maintaining high flow for being able to fill out thin components during molding. Achieving a balance of high flow with high elongation at break can be beneficial. Polyamide resins are desired with low RV (relative viscosity), low AEG, and high carboxylic acid end groups, such as a polyamide having a ratio of carboxylic acid end groups to amine end groups of greater than 1.8:1. Certain polyamide resins that achieve this alone or combinations of polyamide resins may be used.

The AEG content may be obtained/achieved/controlled by treating a conventional lower AEG content polyamide, non-limiting examples of which are provided below. In some cases, AEG level may be obtained/achieved/controlled by controlling the amount of excess hexamethylene diamine (HMD) in the polymerization reaction mixture. HMD is believed to be more volatile than the (di)carboxylic acids that are employed in the reaction, e.g. adipic acid. Generally, the excess HMD in the reaction mixture ultimately affects the level of the AEGs. In some cases, the AEG level may be obtained/achieved/controlled via the incorporation of (mono) amines, e.g., by “capping” some of the end structures with amines, and the monofunctional end capping may be employed to arrive at the aforementioned high AEG level amide polymers.

Exemplary (mono) amines include but are not limited to benzylamine, ethylamine, propylamine, butylamine, pentylamine, hexylamine, 2-ethyl-1-hexylamine, heptylamine, octylamine, nonylamine, decylamine, undecylamine, dodecylamine, amylamine, tert-butyl amine, tetradecylamine, hexadecylamine, or octadecylamine, or any combinations thereof. Exemplary (mono) acids include but are not limited to acetic acid, proprionic acid, butyric acid, valeric acid, hexanoic acid, octanoic acid, palmitic acid, myristic acid, decanoic acid, undecanoic acid, dodecanoic acid, oleic acid, or stearic acid, or any combinations thereof.

The polyamide may also be functionalized by both amine groups and carboxylic acid groups. Surprisingly and unexpectedly, it has been found that by controlling the ratio of carboxylic acid end groups to amine end groups in the polyamide resin, increases in weight average molecular weight, number average molecular weight, z-average molecular weight, polydispersity index, and intrinsic viscosity are minimized from the polyamide resin to the final product, through the compounding process. These improvements also provide for synergistic improvements in mechanical performance, especially at high temperatures.

In some aspects, the ratio of carboxylic acid end groups to amine end groups (COOH:NH₂ ratio) in the polyamide resin is greater than 1.8:1, e.g., greater than 1.9:1, greater than 2:1, greater than 2.1:1, greater than 2.2:1, greater than 2.3:1, or greater than 2.4:1. In terms of upper limits, the ratio of carboxylic acid end groups to amine end groups in the polyamide resin is 3:1 or less, e.g., 2.975:1 or less, 2.95:1 or less, 2.925:1 or less, 2.9:1 or less, 2.875:1 or less, 2.85:1 or less, 2.825:1 or less, 2.8:1 or less, 2.775:1 or less, 2.75:1, 2.725:1 or less, or 2.7:1 or less. In terms of ranges, the ratio of carboxylic acid end groups to amine end groups in the polyamide resin may be from 1.81:1 to 3:1, e.g., from 1.9:1 to 3:1, from 2:1 to 3:1, from 2.1:1 to 2.975:1, from 2:1 to 2.95:1, from 2.2:1 to 2.925:1, from 2.3:1 to 2.9:1, or from 2.4:1 to 2.7:1, including all ranges and values in between.

In some aspects, the carboxylic acid end groups are present in an amount less than 175 μeq/gram polyamide, e.g., less than 170 μeq/gram, less than 160 μeq/gram, or less than 150 μeq/gram. In terms of lower limits, the carboxylic acid end groups are present in an amount of at least 80 μeq/gram, e.g., at least 85 μeq/gram, at least 90 μeq/gram, or at least 95 μeq/gram. In terms of ranges, the carboxylic acid end groups may be present in an amount from 80 to 175 μeq/gram, e.g., from 85 to 160 μeq/gram, from 90 to 140 μeq/gram, or from 95 to 120 μeq/gram. The amine end groups may be present in amounts noted above.

As used herein, delta end groups (DEG or DEGs) are defined as the quantity of amine ends (−NH₂) less the quantity of carboxylic acid ends (−COOH). DEG calculation methods are well known.

As noted above, the base polyamide composition utilizes particular ranges and/or limits of DEG levels. In some embodiments, the base polyamide composition has a DEG level ranging from −31 μeq/gram to −90 μeq/gram, e.g., from −35 μeq/gram to −85 μeq/gram, from −35 μeq/gram to −80 μeq/gram, from −40 μeq/gram to −75 μeq/gram, from −50 μeq/gram to −75 μeq/gram, from −40 μeq/gram to −70 μeq/gram, from −42 μeq/gram to −68 μeq/gram, from −45 μeq/gram to −60 μeq/gram, from −45 μeq/gram to −65 μeq/gram, from −47 μeq/gram to −63 μeq/gram, from −48 μeq/gram to −58 μeq/gram, −50 μeq/gram to −60 μeq/gram, or from −52 μeq/gram to −57 μeq/gram. In terms of lower limits, the base polyamide composition may have a DEG level greater than −85 μeq/gram, e.g. greater than −80 μeq/gram, greater than −75 μeq/gram, greater than −70 μeq/gram, greater than −68 μeq/gram, greater than −65 μeq/gram, greater than −63 μeq/gram, greater than −60 μeq/gram, greater than −58 μeq/gram, greater than −55 μeq/gram, greater than −53 μeq/gram, or greater than −50 μeq/gram. In terms of upper limits, the base polyamide composition may have a DEG level less than −30 μeq/gram, e.g., less than −35 μeq/gram, less than −40 μeq/gram, less than −42 μeq/gram, less than −45 μeq/gram, less than −48 μeq/gram, less than −50 μeq/gram, or less than −52 μeq/gram. These specific DEG levels have also been found to provide for the unexpected combination of advantageous, synergistic properties in the final product, following compounding, as described herein.

The polyamide may have a relative viscosity (RV) of at least 20, e.g., at least 25, at least 30, or at least 35. In terms of upper limits, the polyamide may have an RV of less than 70, e.g., less than 60, less than 55, or less than 50. In terms of ranges, the polyamide may have an RV from 20 to 70, e.g., from 25 to 60, from 30 to 55, or from 35 to 50.

In addition to the above-noted polyamides, the polyamide composition may contain other polyamides which are the same or different from the polyamides noted above.

### Flame Retardant Synergists

Flame retardant synergists may also be used in the flame retardant polyamide composition. The inventors have found that some specific synergists, optionally employed in the disclosed amounts, provide for the aforementioned synergistic combinations of performance features, especially when combined with particular plasticizers. Without being bound by theory, it is posited that these specific synergists in combination with the plasticizers provide the polyamide compositions with elongation-at-break that are suitable and excellent flame-retardant properties, as measured through its UL-94 ratings.

Suitable flame retardant synergists include antimony trioxide, zinc stannate, zinc borate, Safire 400 (commercially available from Huber Engineered Materials), melamine polyphosphate, SFR 100 (commercially available from Momentive), and silicone. The flame retardant synergists may be present in amounts ranging from about 1 wt % to about 10 wt %, for instance 2 wt % to 10 wt %, 2 wt % to 5 wt %, 3 wt % to 10 wt %, 3 wt % to 5 wt %, 3.5 wt % to 10 wt %, or 3.5 wt % to 5 wt %. In terms of upper limits, the additional additives may be present in an amount from 10 wt % or less, from 5 wt % or less, or from 4 wt % or less.

The inventors have unexpectedly found that particular amounts of antimony trioxide, for instance 3.5 wt % to 10 wt %, or 3.5 wt % to 5 wt %, or about 4 wt %, when combined with the polymers noted above, provide even more improved flame retardant properties, for instance providing compositions with a UL-94 rating of V-0.

### Plasticizers

The flame retardant polyamide composition may also contain diundecyl phthalate, a plasticizer. Diundecyl phthalate may be present in amounts ranging from about 1 wt % to about 5 wt %, 2 wt % to 5 wt %, 2.5 wt % to 5 wt %, or 3 wt % to 5 wt %. In terms of lower limits, the diundecyl phthalate may be present in an amount from 1 wt % or more, 2 wt % or more, 2.5 wt % or more, 3 wt % or more. In terms of upper limits, the diundecyl phthalate may be present in an amount from 5 wt % or less, from 3 wt % or less, from 2.5 wt % or less, or from 2 wt % or less.

In one embodiment, triethylene glycol bis(2-ethylhexanoate) is also present in the flame retardant polyamide composition as a plasticizer. The triethylene glycol bis(2-ethylhexanoate), commercialized under the trade name Celanese PLX (sold by Celanese-Azelis Americas) or the trade name Eastman TEG-EH (sold by Eastman Chemical), may be present in amounts ranging from about 1 wt % to about 10 wt %, e.g., from about 1 wt % to about 5 wt %, or from about 2 wt % to about 4 wt %. In terms of lower limits, the plasticizer may be present in an amount from 1 wt % or more, 2 wt % or more, 3 wt % or more, or 4 wt % or more. In terms of upper limits, the additional additives may be present in an amount from 10 wt % or less, 8 wt % or less, 5 wt % or less, from 3 wt % or less, or 2 wt % or less. Other plasticizers known to those of skill in the art may be used in lieu of triethylene glycol bis(2-ethylhexanoate) at the amounts specified above.

The inventors have unexpectedly found that particular amounts of triethylene glycol bis(2-ethylhexanoate) and/or diundecyl phthalate provide improved flame retardant properties, for instance providing compositions with a UL-94 rating of V-0, when combined with the polymers and antimony trioxide components noted above. For instance, the inventors have found that from 1 wt % to 5 wt % diundecyl phthalate, and from 1 wt % to 5 wt % of triethylene glycol bis(2-ethylhexanoate) is particularly effective as the plasticizer component; additionally, the inventors have found that from 2.5 wt % to 5 wt % diundecyl phthalate is particularly effective as the plasticizer component.

### Additives

In some aspects, the composition may also include various additives such as fillers, reinforcing agents, stabilizers, colorants, flow modifiers, fiberglass, synthetic waxes, lubricants, antioxidants, heat stabilizers, and the like, with the proviso that the additives do not adversely affect the desired properties of the flame retardant polyamide compositions. Mixtures of additives may be used. Such additives may be mixed at a suitable time during the mixing of the components for forming the polymeric composition.

In general, the additives may be present in an amount of at least 0.1 wt. %, e.g., at least 0.5 wt. %, at least 1 wt. %, at least 5 wt. %, or at least 10 wt. %. In terms of upper limits, additives may be present in an amount from 50 wt. % or less, from 40 wt. % or less, from 30 wt % or less, from 20 wt % or less, or from 10 wt. % or less. In terms of ranges, additives may be present in an amount from 0.1 to 50 wt. %, e.g., from 1 to 40 wt. %, from 5 to 20 wt. %, from 1 to 10 wt. %, from 0.01 wt % to 3 w %, from 0.1 wt % to 5, from 1 wt % to 5 wt %, or from 10 to 20 wt. %.

In some aspects, the composition may include fiberglass. The fiberglass may be present in an amount of at least 5 wt. %, e.g., at least 10 wt. %, at least 12.5 wt. %, at least 15 wt. %, at least 20 wt. %, or at least 25 wt. %. In terms of upper limits, the fiberglass may be present in an amount from 40 wt. % or less, from 30 wt. % or less, or from 20 wt. % or less. In terms of ranges, the fiberglass may be present in an amount from 5 to 40 wt. %, e.g., from 10 to 30 wt. %, or from 15 to 25 wt. %.

Additional fillers or reinforcing agents include any materials known for these uses. For example, suitable fillers and reinforcing agents include silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); single crystal fibers or “whiskers” such as silicon carbide, alumina, boron carbide, iron, nickel, copper, or the like; fibers (including continuous and chopped fibers) such as carbon fibers, glass fibers, such as E glass, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; reinforcing organic fibrous fillers formed from organic polymers capable of forming fibers such as poly(ether ketone), polyimide, polybenzoxazole, poly(phenylene sulfide), aromatic polyamides, aromatic polyimides, polyetherimides, or the like; as well as additional fillers and reinforcing agents such as mica, feldspar, flue dust, fillite, quartz, quartzite, perlite, tripoli, diatomaceous earth, carbon black, or the like, or combinations comprising at least one of the foregoing fillers or reinforcing agents.

An antioxidant or “stabilizer” (e.g., a hindered phenol and/or secondary aryl amine) and, optionally, a secondary antioxidant (e.g., a phosphate and/or thioester) may also be included as an additive. Suitable antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Suitable antioxidants include Lowinox HD98, commercially available from SI Group, and Irgafos 168, commercially available from BASF. In some embodiments, antioxidants and heat stabilizers are used in combination to avoid adverse chemical effects during processing and to provide it with subsequent long-term resistance to exterior effects such as heat, UV light, weathering, and oxygen (air).

In some embodiments, the polyamide composition may comprise a phenol-containing heat stabilizer. In some embodiments, the phenol-containing heat stabilizer comprises N,N′-hexane-1,6-diylbis[3-(3,5-di-tert-butyl-4-hydroxyphenylpropionamide)]; pentaerythrityl-tetrakis[3-(3,5-di-tert-butyl-4-hydroxyphenyl)propionate]; N,N′-hexamethylenebis(3,5-di-tert-butyl-4-hydroxy-hydrocinnamamide); triethyleneglycol-bis[3-(3-tert-butyl-5-methyl-4-hydroxyphenyl)propionate]; 3,9-bis{2-[3-(3-tert-butyl-4-hydroxy-5-methylphenyl)propionyloxy]-1,1-dimethylethyl }-2,4,8,10-tetraoxaspiro[5,5]undecane; 3,5-di-tert-butyl-4-hydroxybenzylphosphonate-diethyl ester; 1,3,5-trimethyl-2,4,6-tris(3,5-di-tert-butyl-4-hydroxybenzyl)benzene; bis (2,4-dicumylphenyl) pentaerythritol diphosphite plus 1% triisopropanol amine, tetrakis (methylene (3,5-di-(tert)-butyl-4-hydroxyhydrocinnamate)) methane, N,N′-hexamethylene bis (3,5-di-(tert)butyl-hydroxyhydro-cinnamamide), bis(2,4-dicumylphenyl) pentaerythritol diphosphite plus stabilizer, and 1,3,5-tris(4-tert-butyl-3-hydroxy-2,6-dimethylbenzyl)isocyanurate, or combinations thereof.

Suitable commercial phenol-containing heat stabilizers include IRGANOX 1010, IRGANOX 1098, and IRGANOX 1076, from CIBA Specialty Chemicals, IRGAFOS 168 from CIBA Specialty Chemicals, DOVERPHOS S-9228T from Dover Chemical Corporation, or combinations thereof.

In some embodiments, the polyamide composition comprises the phenol-containing heat stabilizer in an amount ranging from 0.1 wt. % to 2 wt. %, based on the total weight of the polyamide composition, e.g., from 0.2 wt. % to 1.8 wt. %, from 0.3 wt. % to 1.7 wt. %, from 0.4 wt. % to 1.6 wt. %, from 0.5 wt. % to 1.5 wt. %, from 0.6 wt. % to 1.4 wt. %, from 0.7 wt. % to 1.3 wt. %, from 0.8 wt. % to 1.2 wt. %, or from 0.9 wt. % to 1.1 wt. %. In terms of upper limits, the polyamide composition comprises the phenol-containing heat stabilizer in an amount less than 2 wt. %, e.g., less than 1.9 wt. %, less than 1.8 wt. %, less than 1.6 wt. %, less than 1.4 wt. %, less than 1.2 wt. %, or less than 1.1 wt. %. In terms of lower limits, the polyamide composition comprises the phenol-containing heat stabilizer in an amount greater than 0.1 wt. %, based on the total weight of the polyamide composition, e.g., greater than 0.1 wt. %, greater than 0.2 wt. %, greater than 0.3 wt. %, greater than 0.4 wt. %, greater than 0.5 wt. %, greater than 0.6 wt. %, greater than 0.7 wt. %, greater than 0.8 wt. %, or greater than 0.9 wt. %. It was found that these specific quantities of the phenol-containing heat stabilizer provide good heat aging properties while also satisfying a non-halogen rating.

In some embodiments, the polyamide composition may comprise an amine-containing heat stabilizer. In some embodiments, the amine-containing heat stabilizer comprises an aromatic amine, a hindered amine, or combinations thereof. In some embodiments, the amine-containing heat stabilizer comprises bis(4-(1-methyl-1-phenylethyl)phenyl)amine, 2-ethyl-2′-ethoy-oxal anilide, imethyl glyoxime, 2,2′-bipyridine, 1,10-phenanthroline, ortho-phenylenediamine, 1,2-diaminocyclohexane, 1,4-diamino butane, urea, 8-hydroxyquinoline, substituted urea, and combinations thereof.

Suitable commercial amine-containing heat stabilizers include NYLOSTAB S-EED from Clariant, NAUGARD 445 from Addivant, OKABEST FLEX, OKABEST ULTRA-FLEX, OKABEST S-FLEX, OKABEST S-FLEX 2, OKABEST S-FLEX 3, OKAFLEX U, and OKAFLEX EM from OKA-Tec, or combinations thereof.

In some embodiments, the polyamide composition comprises the amine-containing heat stabilizer in an amount ranging from 0.1 wt. % to 2 wt. %, based on the total weight of the polyamide composition, e.g., from 0.2 wt. % to 1.8 wt. %, from 0.3 wt. % to 1.7 wt. %, from 0.4 wt. % to 1.6 wt. %, from 0.5 wt. % to 1.5 wt. %, from 0.6 wt. % to 1.4 wt. %, from 0.7 wt. % to 1.3 wt. %, from 0.8 wt. % to 1.2 wt. %, or from 0.9 wt. % to 1.1 wt. %. In terms of upper limits, the polyamide composition comprises the amine-containing heat stabilizer in an amount less than 2 wt. %, e.g., less than 1.9 wt. %, less than 1.8 wt. %, less than 1.6 wt. %, less than 1.4 wt. %, less than 1.2 wt. %, or less than 1.1 wt. %. In terms of lower limits, the polyamide composition comprises the amine-containing heat stabilizer in an amount greater than 0.1 wt. %, based on the total weight of the polyamide composition, e.g., greater than 0.2 wt. %, greater than 0.3 wt. %, greater than 0.4 wt. %, greater than 0.5 wt. %, greater than 0.6 wt. %, greater than 0.7 wt. %, greater than 0.8 wt. %, or greater than 0.9 wt. %. It was found that these specific quantities of the amine-containing heat stabilizer provide good heat aging properties while also satisfying a non-halogen rating.

The inventors have discovered that utilizing particular copper-containing heat stabilizers (in particular amounts), and optionally with specific additives, results in synergistic heat stabilizer packages that provide for excellent heat aging properties and non-halogen ratings, and also minimize or eliminate the amount of free copper introduced into the polyamide composition. For example, in some embodiments, the content of a copper-containing heat stabilizer is limited to satisfy a non-halogen rating and also provides superior heat aging properties for the polyamide composition without adding free copper to the polyamide composition. The inventors have also found that the addition of particular copper complexing agent, e.g., phosphorus-containing compounds, complexes any free copper that may be present in the polyamide composition. In other cases, the use of additional copper-containing heat stabilizers that contain complexed copper, can also reduce the amount of free copper in the polyamide composition, which in turn reduces contact corrosion in the final polyamide composition. Further, the copper-containing heat stabilizer provides a polyamide composition having a high relative temperature index (RTI). The polyamide composition may comprise one or more heat stabilizers. In some embodiments, the polyamide composition includes a copper-containing heat stabilizer. In some embodiments, the copper-containing heat stabilizer comprises copper, a halogen, (or a copper halide—a compound containing copper and a halogen), and optionally an organobromine-phosphorus compound. In some aspects, the copper-containing heat stabilizer comprises a copper iodide/bis(triphenylphosphine) complex.

These copper halide and organobromine-phosphorus compound combinations, when added to the polyamides described herein, result in polyamide compositions that exhibit superior heat stability while also maintaining excellent electrical properties, thus making the polyamide compositions of the present invention ideally suited for use in the electrical/electronic industries. As a further benefit, this combination of a copper halide and an organophosphorus compound does not discolor the polyamide composition.

Suitable commercial copper-containing heat stabilizers include BRUGGOLEN® H3386 (available from Brüggemann Chemical) (copper iodide/bis(triphenylphosphine) complex).

As described above, a polyamide composition comprising a copper-containing heat stabilizer including halogen compounds, e.g., organobromine-phosphorus compound, may have the potential to exceed the halogen content for a non-halogen rating. To avoid exceeding the halogen content limits, the polyamide composition may comprise the copper-containing heat stabilizer in particular amounts.

In some embodiments, the polyamide composition comprises the copper-containing heat stabilizer in an amount ranging from 0.01 wt. % to 0.29 wt. %, based on the total weight of the polyamide composition, e.g., from 0.05 wt. % to 0.28 wt. %, from 0.08 wt. % to 0.275 wt. %, from 0.1 wt. % to 0.27 wt. %, from 0.12 wt. % to 0.26 wt. %, from 0.14 wt. % to 0.25 wt. %, from 0.15 wt. % to 0.24 wt. %, from 0.16 wt. % to 0.23 wt. %, or from 0.17 wt. % to 0.22 wt. %. In terms of upper limits, the polyamide composition comprises the copper-containing heat stabilizer in an amount less than 0.29 wt. %, based on the total weight of the polyamide composition, e.g., less than 0.28 wt. %, less than 0.27 wt. %, less than 0.26 wt. %, less than 0.25 wt. %, less than 0.24 wt. %, less than 0.23 wt. %, less than 0.22 wt. %, less than 0.21 wt. %, or less than 0.20 wt. %. In terms of lower limits, the polyamide composition comprises the copper-containing heat stabilizer in an amount greater than 0.01 wt. %, based on the total weight of the polyamide composition, e.g., greater than 0.02 wt. %, greater than 0.04 wt. %, greater than 0.05 wt. %, greater than 0.06 wt. %, greater than 0.08 wt. %, greater than 0.1 wt. %, greater than 0.12 wt. %, greater than 0.14 wt. %, or greater than 0.15 wt. %. It was found that these specific quantities of the copper-containing heat stabilizer provide good heat aging properties while also satisfying a non-halogen rating.

Flame retardant synergists may also be used in the flame retardant polyamide composition. Suitable flame retardant synergists include antimony trioxide, zinc stannate, zinc borate, Safire 400 (commercially available from Huber Engineered Materials), melamine polyphosphate, SFR 100 (commercially available from Momentive), and silicone. The flame retardant synergists may be present in amounts ranging from about 1 wt % to about 5 wt %. In terms of upper limits, the additional additives may be present in an amount from 5 wt % or less, from 3 wt % or less, or from 2 wt % or less.

Light stabilizers and/or ultraviolet light (UV) absorbing additives may also be used. Suitable light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers.

Suitable UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™5411); 2-hydroxy-4-n-octyloxybenzophenone (CYASORB™531); 2-[4,6-bis(2,4-dimethylphenyl)-1,3,5-triazin-2-yl]-5-(octyloxy)-phenol (CYASORB™1164); 2,2′-(1,4-phenylene)bis(4H-3,1-benzoxazin-4-one) (CYASORBTM UV-3638); 1,3-bis[(2-cyano-3,3-diphenylacryloyl)oxy]-2,2-bis[[(2-cyano-3, 3-diphenylacryloyl)oxy]methyl]propane (UVINUL™3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than about 100 nanometers; or the like, or combinations comprising at least one of the foregoing UV absorbers. based on 100 parts by weight of the polymeric components of the polymeric composition.

In some aspects, the fillers include zinc borate and zinc stearate. When included, the fillers may be present in an amount of at least 0.01 wt. %, e.g., at least 0.05 wt. %, at least 0.075 wt. %, or at least 0.1 wt. %. In terms of upper limits, the fillers may be present in an amount from 5 wt. % or less, from 4.75 wt. % or less, from 4.5 wt. % or less, or from 4.25 wt. % or less. In terms of ranges, the fillers may be present in an amount from 0.01 to 5 wt. %, e.g., from 0.05 to 4.75 wt. %, from 0.1 to 4.5 wt. %, or from 0.1 to 4.5 wt. %. In some embodiments, the polyamide composition may comprise one or more of zinc borate and zinc stearate.

In some embodiments, the polyamide composition may comprise zinc borate in an amount of at least 0.01 wt. %, e.g., at least 0.05 wt. %, at least 0.075 wt. %, or at least 0.1 wt. %. In terms of upper limits, zinc borate may be present in an amount from 3 wt. % or less, from 2.75 wt. % or less, from 2.5 wt. % or less, or from 2 wt. % or less. In terms of ranges, zinc borate may be present in an amount from 0.01 to 3 wt. %, e.g., from 0.05 to 2.5 wt. %, from 0.1 to 2 wt. %, or from 0.5 to 1.5 wt. %.

Plasticizers, lubricants, and/or mold release agents additives may also be used. There is considerable overlap among these types of materials, which include, for example, triethylene glycol bis(2-ethylhexanoate), phthalic acid esters such as dioctyl-4,5-epoxy-hexahydrophthalate; tris-(octoxycarbonylethyl)isocyanurate; tristearin; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate, and aluminum, calcium, or zinc stearate; mixtures of the stearate compound and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax, or synthetic waxes, such as Arcawax C (commercially available from Lonza).

In one embodiment, triethylene glycol bis(2-ethylhexanoate) is present in the flame retardant polyamide composition as a plasticizer. The triethylene glycol bis(2-ethylhexanoate), commercialized under the trade name Celanese PLX (sold by Celanese-Azelis Americas), may be present in amounts ranging from about 1 wt % to about 10 wt %, e.g., from about 1 wt % to about 5 wt %, or from about 2 wt % to about 4 wt %. In terms of lower limits, the plasticizer may be present in an amount from 1 wt % or more, 2 wt % or more, 3 wt % or more, or 4 wt % or more. In terms of upper limits, the additional additives may be present in an amount from 10 wt % or less, 8 wt % or less, 5 wt % or less, from 3 wt % or less, or 2 wt % or less. Other plasticizers known to those of skill in the art may be used in lieu of triethylene glycol bis(2-ethylhexanoate) at the amounts specified above.

The flame retardant polyamide composition may also contain diundecyl phthalate, a plasticizer. Diundecyl phthalate may be present in amounts ranging from about 1 wt % to about 5 wt %. In terms of lower limits, the diundecyl phthalate may be present in an amount from 1 wt % or more, 2 wt % or more, 3 wt % or more. In terms of upper limits, the diundecyl phthalate may be present in an amount from 5 wt % or less, from 3 wt % or less, or from 2 wt % or less.

Colorants such as pigment and/or dye additives may also be present. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the foregoing pigments. The colorants (or color package) may be present in amounts ranging from 0 to 10 wt %, or 1 wt % to 5 wt %. In terms of lower limits, the colorants may be present in an amount from 1 wt % or more, 2 wt % or more, 3 wt % or more. In terms of upper limits, the colorants may be present in an amount from 10 wt % or less, from 5 wt % or less, or from 2 wt % or less.

Additional additives, when present, may be present in an amount of at least 0.01 wt. %, e.g., at least 0.05 wt. %, at least 0.075 wt. %, or at least 0.1 wt. %. In terms of upper limits, the additional additives may be present in an amount from 4 wt. % or less, from 3 wt. % or less, from 2.75 wt. % or less, or from 2.5 wt. % or less. In terms of ranges, the additional additives may be present in an amount from 0.01 to 4 wt. %, e.g., from 0.05 to 3 wt. %, from 0.1 to 2.75 wt. %, or from 0. to 2.5 wt. %.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

These components mentioned herein may be considered optional. In some cases, the disclosed compositions may expressly exclude one or more of the aforementioned components in this section, e.g., via claim language. For example, claim language may be modified to recite that the disclosed compositions, processes, etc., do not utilize or comprise one or more of the aforementioned components, e.g., the compositions do not include an anime antioxidant or a UV absorbing additive.

### Performance Characteristics

The flame retardant polyamide compositions described herein demonstrate surprising performance results. For example, the polyamide compositions demonstrate superior elongation at break and UL-94 ratings. These performance parameters are exemplary and the examples support other performance parameters that are contemplated by the disclosure. It is contemplated that the molded flame retardant polyamide products produced from the polyamide compositions described herein can have the properties described below.

In some embodiments, the flame retardant polyamide composition demonstrates an elongation at break of at least 8%, at least 9%, at least 9.5%, at least 10%, at least 11%, at least 12%, at least 13%, or at least 14%.

In other embodiments, the flame retardant polyamide composition demonstrates UL-94 rating of V-2 or better, such as V-1 or better, or V-0 or better. The polyamide composition can be measured at various thicknesses for the UL-94 rating, including 0.4 mm, 0.75 mm, 1.5 mm, and 3.0 mm. In one embodiment, the flame retardant composition has a V-0 rating when measured at one or more of the 0.4 mm, 0.75 mm, 1.5 mm, and 3.0 mm thickness measurements; in another embodiment, the flame retardant composition has a V-0 rating when measured at each of 0.4 mm, 0.75 mm, 1.5 mm, and 3.0 mm thicknesses.

Generally, tensile elongation measurements may be conducted under ISO 527 (2018 or 2019).

A glow wire-based test that is often-used test for determining the flame retardancy of various polymeric compositions is the Glow Wire Ignition Temperature (GWIT). This test simulates the effect of heat as it may arise in malfunctioning electrical equipment, such as with overloaded or glowing components. The test provides a way of comparing the temperatures at which thermoplastic resin compositions ignite under these circumstances. Glow Wire Flammability Index (GWFI) can be performed on samples at various thicknesses (0.4, 0.75, 1.5, and 3.0 mm) according to IEC 60695-2-12.

In one embodiment, the composition exhibits a GWIT of 775° C. or greater, e.g. 800° C. or greater, 825° C. or greater, 850° C. or greater, 875° C. or greater, 900° C. or greater.

One well-known proxy for determining an articles sufficiency of electrical resistance is the comparative tracking index (CTI) test. This property is useful for applications in many fields, such as the field of electronics, as it measures the electrical breakdown properties, also known as tracking, of the material. The number denotes the voltage at which the material with a thickness of 3 mm can withstand 50 drops (or 100 drops) of ammonium chloride solution. Comparative Tracking Index (CTI) may be measured according to both IEC 60112 and ASTM D3638.

In one embodiment, the flame retardant polyamide composition exhibits a comparative tracking index of 300V or greater, e.g. 325V or greater, 350V or greater, 375V or greater, or 400V or greater.

### Method of Forming the Final Molded Product

As described herein, the composition may be compounded and then extruded or injection molded to form a final product.

### Applications

The inventive compositions are useful in a variety of applications due to their thermal stability, flowability, processability, and recyclability. The products may be used in electric and electrical applications, including in connectors, relays, terminal blocks, motors, walls plates, lighting, circuit breakers, switches, and sensors, as well as other applications.

Thus, the products are used in air or liquid filtration in the following sectors: transportation; industrial; commercial and residential.

### EXAMPLES

Working Examples 1-4and Comparative Examples A-M were prepared and tested for elongation at break and effectiveness as a fire retardant. The results are shown in Table I and Table II, below. Comparative Example E represents a control example, using only DBDPE and no brominated epoxy polymers. The remaining working Examples and Comparative Examples employed varying amounts of F-2400 (an epoxy-terminated brominated epoxy polymer), F-3100 (a tribromophenol end-capped brominated epoxy polymer), HP-3010 (a brominated polystyrene compound), and PBS-64HW (a brominated polystyrene compound).

TABLE 1

| Ingredient | Ex. 1 | Ex. 2 | Ex. 3 | Ex. 4 | Comp. A | Comp. B | Comp. C | Comp. D | Comp. E |
|---|---|---|---|---|---|---|---|---|---|
| PA resin | 60.8 | 62.8 | 60.8 | 66.8 | 60.8 | 60.8 | 64.8 | 64.8 | 72.8 |
| Ground PA resin | 6.60 | 4.60 | 5.60 | 0.6 | 6.60 | 6.60 | 4.60 | 4.60 | 3.60 |
| F-2400 | 14.0 | 14.0 | 14.0 | 14.0 | 16.0 | 12.0 | — | — | — |
| F-3100 | 10.0 | 10.0 | 10.0 | 10.0 | 8.0 | 12.0 | 12.0 | 12.0 | — |
| SAYTEX HP-3010 | | | | | | | 12.0 | | |
| Firemaster PBS64HW | | | | | | | | 12.0 | |
| SAYTEX 8010 | | | | | | | | | 18.00 |
| Diundecyl Phthalate | 2.00 | 2.00 | | 2.0 | 2.00 | 2.00 | 2.00 | 2.00 | 2.00 |
| Celanese PLX Plast | 2.00 | 2.00 | 4.00 | | 2.00 | 2.00 | | | |
| Eastman TEG-EH | | | | 2.0 | | | | | |
| Antimony Trioxide | 4.00 | 4.00 | 3.00 | 4.0 | 4.00 | 4.00 | 4.00 | 4.00 | 3.00 |
| Acrawax C, Prill | 0.10 | 0.10 | 0.10 | 0.1 | 0.10 | 0.10 | 0.10 | 0.10 | 0.10 |
| Lowinox HD98 | 0.50 | 0.50 | 0.50 | 0.5 | 0.50 | 0.50 | 0.50 | 0.50 | 0.50 |
| Zinc borate | | | 2.00 | | | | | | |
| Sum | 100.0 | 100.0 | 100.0 | 100.0 | 100.0 | 100.0 | 100.0 | 100.0 | 100.0 |

Performance

| | | | | | | | | | |
|---|---|---|---|---|---|---|---|---|---|
| Elongation at break, % | 13.4 | 13.9 | 9.9 | 9.9 | 8.5 | 6.7 | 4.4 | 6.6 | 24.3 |
| UL-94 | V-0 | V-0/V-0/ | V-0 | V-0/V-0/ | V-0 | V-0 | V-0/V-1 | V-0/ | V-0 |
| | | V-2/V-0 | | V-0/V-0 | | | | V-2/V-1 | |

TABLE 2

| Ingredient | Comp. F | Comp. G | Comp. H | Comp. I | Comp. J | Comp. K | Comp. L | Comp. M |
|---|---|---|---|---|---|---|---|---|
| PA resin | 61.8 | 60.8 | 64.8 | 62.8 | 62.8 | 62.8 | 64.8 | 62.8 |
| Ground PA resin | 5.60 | 5.60 | 4.60 | 4.60 | 4.60 | 4.60 | 4.60 | 4.60 |
| F-2400 | 12.0 | 12.0 | 14.0 | 14.0 | 15.0 | 13.0 | | |
| F-3100 | 12.0 | 12.0 | 10.0 | 10.0 | 9.0 | 11.0 | 10.0 | 10.0 |
| SAYTEX HP-3010 | | | | | | | 14.0 | 14.0 |
| Diundecyl Phth. | 2.00 | 2.00 | 2.00 | | | | | |
| Celanese PLX | 2.00 | 2.00 | | 4.00 | 4.00 | 4.00 | 2.00 | 4.00 |
| Eastman TEG-EH | | | | | | | | |
| Antimony Trioxide | 3.00 | 3.00 | 4.00 | 4.00 | 4.00 | 4.00 | 4.00 | 4.00 |
| Acrawax C, Prill | 0.10 | 0.10 | 0.10 | 0.10 | 0.10 | 0.10 | 0.10 | 0.10 |
| Lowinox HD98 | 0.50 | 0.50 | 0.50 | 0.50 | 0.50 | 0.50 | 0.50 | 0.50 |
| Zinc borate | 1.00 | 2.00 | | | | | | |
| Sum | 100 | 100.0 | 100.0 | 100.0 | 100.0 | 100.0 | 100.0 | 100.0 |

Performance

| | | | | | | | | |
|---|---|---|---|---|---|---|---|---|
| Elongation at break, % | 9.2 | 7.6 | 6.3 | 4.7 | 4.1 | 5.2 | 5.3 | 6.6 |
| UL-94 | V-2/V-1 | V-2/Burn | | | | | | |

As can be seen in the above tables, Examples 1, 2, 3, and 4 showed an unexpected improvement in both elongation at break and UL-94 rating. Each of those Examples contained the disclosed amounts of epoxy-terminated brominated epoxy polymer, e.g., 14 wt %; the disclosed amounts of tribromophenol end-capped brominated epoxy polymer, e.g., 10 wt %; 1-5 wt % plasticizer; and no DBDPE. These four examples demonstrate the unexpected synergy using specific weights percentages of an epoxy-terminated brominated epoxy polymer and a tribromophenol end-capped brominated epoxy polymer. When the weight percentages of these components varied outside the disclosed range, sometimes even slightly outside the claimed ranges, the resulting compositions were not able to show the synergistic combination of both improvement in elongation at break and superior fire retardant properties.

### EMBODIMENTS

Embodiment 1:A flame retardant polyamide composition comprising from 50 wt % to 75 wt % of a polyamide; less than 18 wt % of a DBDPE flame retardant; from 12.1 wt % to 15.9 wt % of an epoxy-terminated brominated epoxy polymer; from 8.1 wt % to 11.9 wt % of a tribromophenol end-capped brominated epoxy polymer; and either (a) from 1 wt % to 10 wt % of two or more plasticizers, or (b) from 1 wt % to 5% of one or more plasticizers and from 1 wt % to 5 wt % of one or more flame retardant synergists. The polyamide composition demonstrates an elongation of break of at least 9%, and the polyamide composition demonstrates a UL-94 rating of V-2 or better.

Embodiment 2: An embodiment according to embodiment 1, wherein the composition comprises from 13 wt % to 15 wt % of an epoxy-terminated brominated epoxy polymer.

Embodiment 3: An embodiment according to embodiment 1, wherein the composition comprises from 9 wt % to 11 wt % a tribromophenol end-capped brominated epoxy polymer.

Embodiment 4: An embodiment according to embodiment 1, wherein the epoxy-terminated brominated epoxy polymer is an epoxy-terminated, tetrabromobisphenol-A brominated epoxy polymer.

Embodiment 5: An embodiment according to embodiment 1, wherein the tribromophenol end-capped brominated epoxy polymer is a tribromophenol end-capped, tetrabromobisphenol-A brominated epoxy polymer.

Embodiment 6: An embodiment according to embodiment 1, wherein the epoxy-terminated brominated epoxy polymer has a molecular weight ranging from 30,000 to 70,000.

Embodiment 7: An embodiment according to embodiment 1, wherein the epoxy-terminated brominated epoxy polymer has a molecular weight ranging from 20,000 to 30,000.

Embodiment 8: An embodiment according to embodiment 1, wherein the tribromophenol end-capped brominated epoxy polymer has a molecular weight ranging from 10,000 to 20,000.

Embodiment 9: An embodiment according to embodiment 1, wherein the polyamide is a PA6,6; PA6; PA6/66; PA66/6; PA6/10; PA6/11, PA6/12; PA10; PA11; or PA12; or copolymers or blends thereof.

Embodiment 10: An embodiment according to embodiment 9, wherein the polyamide is PA6,6 and/or PA6.

Embodiment 11: An embodiment according to embodiment 1, wherein the polyamide is PA6T/66 or PA6TDT

Embodiment 12: An embodiment according to embodiment 1, wherein the DBDPE is present in amounts less than 10 wt %, preferably wherein the polyamide composition is free of DBDPE.

Embodiment 13: An embodiment according to embodiment 1, wherein the epoxy-terminated brominated epoxy polymer is present in amounts between 12 and 15 wt %; the tribromophenol end-capped brominated epoxy polymer is present in amounts between 9 and 12 wt %; and the polyamide composition is free of DBDPE.

Embodiment 14: An embodiment according to embodiment 1, wherein the composition further comprises one or more brominated polystyrene compounds.

Embodiment 15: An embodiment according to embodiment 1, wherein the composition further comprises about 1 to about 5 wt % of diundecyl phthalate.

Embodiment 16: An embodiment according to embodiment 1, wherein the plasticizer is triethylene glycol bis(2-ethylhexanoate), present in amount ranging from about 1 to about 5 wt %.

Embodiment 17: An embodiment according to embodiment 1, wherein the composition further comprises about 1 to about 5 wt % of one more flame retardant synergists selected from the group consisting of antimony trioxide, zinc stannate, zinc borate, Safire 400, melamine polyphosphate, SFR 100, and silicone.

Embodiment 18: An embodiment according to embodiment 1, further comprising 0.01 to 3 wt % synthetic wax; 0.01 to 3 wt % lubricants, such as aluminum, calcium or zinc stearate; 0.1 to 5 wt % antioxidant; 0.1 to 30 wt % heat stabilizer; 0 to 30 wt % of fiberglass; and/or 0 to 10 wt % of a color package.

Embodiment 19: An embodiment of embodiment 1, wherein the polyamide composition has an elongation at break of at least 10%.

Embodiment 20: An embodiment of embodiment 1, wherein the polyamide composition has a UL-94 rating of V-0 or better.

Embodiment 21: A flame retardant polyamide composition comprising from 50 wt % to 75 wt % of a polyamide; less than 18 wt % of a DBDPE flame retardant; from 11 wt % to 16 wt % of one or more compounds selected from the group consisting of epoxy-terminated brominated epoxy polymers and brominated polystyrene compounds; from 8 wt % to 13 wt % of a tribromophenol end-capped brominated epoxy polymer; and from 1 wt % to 10 wt % of one or more plasticizers. The polyamide composition demonstrates an elongation of break of at least 9%, and wherein the polyamide composition demonstrates a UL-94 rating of V-2 or higher.

Embodiment 22: An embodiment of embodiment 21, wherein the polyamide is PA6,6 and/or PA6.

Embodiment 23: An embodiment of embodiment 21, wherein the DBDPE is present in amounts less than 10 wt %, preferably wherein the polyamide composition is free of DBDPE.

Embodiment 24: An embodiment of embodiment 1, wherein polyamide is modified with amine end groups and carboxylic acid end groups.

Embodiment 25: An embodiment of embodiment 24, wherein the COOH:NH₂ ratio of the modified polyamide is 1.8 or greater.

Embodiment 26: An embodiment of embodiment 1, wherein the composition exhibits a glow wire ignition temperature (GWIT) of 775° C. or greater.

Embodiment 27: An embodiment of embodiment 1, wherein the composition exhibits a comparative tracking index of 300V or greater.

Embodiment 28: A flame retardant polyamide composition comprising from 50 wt % to 75 wt % of a polyamide; less than 18 wt % of a DBDPE flame retardant; from 10 wt % to 18 wt % of an epoxy-terminated brominated epoxy polymer; from 6 wt % to 14 wt % of a tribromophenol end-capped brominated epoxy polymer; from 3.5 wt % to 10 wt % antimony trioxide; and (a) from 1 wt % to 5 wt % diundecyl phthalate plasticizer, and from 1 wt % to 5 wt % of triethylene glycol bis(2-ethylhexanoate) plasticizer, or (b) from 2.5 wt % to 5 wt % diundecyl phthalate plasticizer. The polyamide composition demonstrates an elongation of break of at least 8%, and the polyamide composition demonstrates a UL-94 rating of V-0.

Embodiment 29: An embodiment according to embodiment 28, wherein the composition comprises from 12 wt % to 16 wt % of an epoxy-terminated brominated epoxy polymer.

Embodiment 30: An embodiment according to embodiment 28, wherein the composition comprises from 8 wt % to 12 wt % a tribromophenol end-capped brominated epoxy polymer.

Embodiment 31: An embodiment according to embodiment 28, wherein the epoxy-terminated brominated epoxy polymer is an epoxy-terminated, tetrabromobisphenol-A brominated epoxy polymer.

Embodiment 32: An embodiment according to embodiment 28, wherein the tribromophenol end-capped brominated epoxy polymer is a tribromophenol end-capped, tetrabromobisphenol-A brominated epoxy polymer.

Embodiment 33: An embodiment according to embodiment 28, wherein the epoxy-terminated brominated epoxy polymer has a molecular weight ranging from 30,000 to 70,000.

Embodiment 34: An embodiment according to embodiment 28, wherein the tribromophenol end-capped brominated epoxy polymer has a molecular weight ranging from 10,000 to 20,000.

Embodiment 35: An embodiment according to embodiment 28, wherein the polyamide is a PA6,6; PA6; PA6/66; PA66/6; PA6/10; PA6/11, PA6/12; PA10; PA11; or PA12; or copolymers or blends thereof.

Embodiment 36: An embodiment according to embodiment 35, wherein the polyamide is PA6,6 and/or PA6.

Embodiment 37: An embodiment according to embodiment 28, wherein the DBDPE is present in amounts less than 10 wt %.

Embodiment 38: An embodiment according to embodiment 37, wherein the polyamide composition is free of DBDPE.

Embodiment 39: An embodiment according to embodiment 28, wherein the epoxy-terminated brominated epoxy polymer is present in amounts between 12 and 16 wt %; the tribromophenol end-capped brominated epoxy polymer is present in amounts between 8 and 12 wt %; and the polyamide composition is free of DBDPE.

Embodiment 40: An embodiment according to embodiment 28, wherein the composition further comprises one or more brominated polystyrene compounds.

Embodiment 41: An embodiment according to embodiment 28, wherein the composition comprises 1 wt % to 5 wt % of diundecyl phthalate plasticizer, and from 1 wt % to 5 wt % of triethylene glycol bis(2-ethylhexanoate) plasticizer.

Embodiment 42: An embodiment according to embodiment 28, wherein the composition comprises 2.5 wt % to 5 wt % of diundecyl phthalate plasticizer.

Embodiment 43: An embodiment according to embodiment 28, wherein the antimony trioxide is present in amounts ranging from 3.5 wt % to 5 wt %.

Embodiment 44: An embodiment according to embodiment 28, wherein the composition further comprises about 1 to about 5 wt % of one more flame retardant synergists selected from the group consisting of antimony trioxide, zinc stannate, zinc borate, Safire 400, melamine polyphosphate, SFR 100, and silicone.

Embodiment 45: An embodiment according to embodiment 28, further comprising 0.01 to 3 wt % synthetic wax; 0.01 to 3 wt % lubricants, such as aluminum, calcium or zinc stearate; 0.1 to 5 wt % antioxidant; 0.1 to 30 wt % heat stabilizer; 0 to 30 wt % of fiberglass; and/or 0 to 10 wt % of a color package.

Embodiment 46: An embodiment of embodiment 28, wherein the polyamide composition has an elongation at break of at least 9%.

Embodiment 47: An embodiment of embodiment 28, wherein the polyamide composition has a UL-94 rating of V-0 when measured at 0.4 mm, 0.75 mm, 1.5 mm, and 3.0 mm.

While the disclosure has been described in detail, modifications within the spirit and scope of the disclosure will be readily apparent to those of skill in the art. Such modifications are also to be considered as part of the present disclosure. In view of the foregoing discussion, relevant knowledge in the art and references discussed above in connection with the Background, the disclosures of which are all incorporated herein by reference, further description is deemed unnecessary. In addition, it should be understood from the foregoing discussion that aspects of the disclosure and portions of various embodiments may be combined or interchanged either in whole or in part. Furthermore, those of ordinary skill in the art will appreciate that the foregoing description is by way of example only, and is not intended to limit the disclosure. Finally, all patents, publications, and applications referenced herein are incorporated by reference in their entireties.

What is claimed is:

1. A flame retardant polyamide composition comprising:
from 50 wt % to 75 wt % of a polyamide;
less than 18 wt % of a decabromodiphenyl ethane (DBDPE) flame retardant;
from 12.1 wt % to 15.9 wt % of an epoxy-terminated brominated epoxy polymer;
from 8.1 wt % to 11.9 wt % of a tribromophenol end-capped brominated epoxy polymer; and
either (a) from 1 wt % to 10 wt % of two or more plasticizers, or (b) from 1 wt % to 5% of one or more plasticizers and from 1 wt % to 5 wt % of one or more flame retardant synergists;
wherein the polyamide composition demonstrates an elongation of break of at least 9%, and
wherein the polyamide composition demonstrates a UL-94 rating of V-2 or better.

2. The flame retardant polyamide composition according to claim 1, wherein the composition comprises from 13 wt % to 15 wt % of an epoxy-terminated brominated epoxy polymer.

3. The flame retardant polyamide composition according to claim 1, wherein the composition comprises from 9 wt % to 11 wt % of a tribromophenol end-capped brominated epoxy polymer.

4. The flame retardant polyamide composition according to claim 1, wherein the epoxy-terminated brominated epoxy polymer is an epoxy-terminated, tetrabromobisphenol-A brominated epoxy polymer.

5. The flame retardant polyamide composition according to claim 1, wherein the tribromophenol end-capped brominated epoxy polymer is a tribromophenol end-capped, tetrabromobisphenol-A brominated epoxy polymer.

6. The flame retardant polyamide composition according to claim 1, wherein the epoxy-terminated brominated epoxy polymer has a molecular weight ranging from 30,000 to 70,000.

7. The flame retardant polyamide composition according to claim 1, wherein the epoxy-terminated brominated epoxy polymer has a molecular weight ranging from 20,000 to 30,000.

8. The flame retardant polyamide composition according to claim 1, wherein the tribromophenol end-capped brominated epoxy polymer has a molecular weight ranging from 10,000 to 20,000.

9. The flame retardant polyamide composition according to claim 1, wherein the polyamide is a PA6,6; PA6; PA6/66; PA66/6; PA6/10; PA6/11, PA6/12; PA10; PA11; or PA12; or copolymers or blends thereof.

10. The flame retardant polyamide composition according to claim 9, wherein the polyamide is PA6,6 and/or PA6.

11. The flame retardant polyamide composition according to claim 1, wherein the polyamide is PA6T/66 or PA6TDT.

12. The flame retardant polyamide composition according to claim 1, wherein the DBDPE is present in amounts less than 10 wt %, preferably wherein the polyamide composition is free of DBDPE.

13. The flame retardant polyamide composition according to claim 1, wherein the epoxy-terminated brominated epoxy polymer is present in amounts between 13 and 15 wt %; the tribromophenol end-capped brominated epoxy polymer is present in amounts between 9 and 11 wt %; and the polyamide composition is free of DBDPE.

14. The flame retardant polyamide composition according to claim 1, wherein the composition further comprises one or more brominated polystyrene compounds.

15. The flame retardant polyamide composition according to claim 1, wherein one of the plasticizers is diundecyl phthalate, present in an amount from 1 wt % to 5 wt %.

16. The flame retardant polyamide composition according to claim 1, wherein one of the plasticizers is triethylene glycol bis(2-ethylhexanoate), present in amount ranging from 1 wt % to 5 wt %.

17. The flame retardant polyamide composition according to claim 1, wherein the flame retardant synergist is selected from the group consisting of antimony trioxide, zinc stannate, zinc borate, Safire 400, melamine polyphosphate, SFR 100, and silicone.

18. The flame retardant polyamide composition according to claim 1, further comprising:
0.01 to 3 wt % synthetic wax;
0.01 to 3 wt % lubricants;
0.1 to 5 wt % antioxidant;
0.1 to 5 wt % heat stabilizer;
0 to 30 wt % of fiberglass; and/or
0 to 10 wt % of a color package.

19. The flame retardant polyamide composition according to claim 1, wherein the polyamide composition has an elongation at break of at least 10%.

20. The flame retardant polyamide composition according to claim 1, wherein the polyamide composition has a UL-94 rating of V-0 or better.

21. The flame retardant polyamide of claim 1, wherein polyamide is modified with amine end groups and carboxylic acid end groups.

22. The flame retardant polyamide of claim 24, wherein the COOH:NH2 ratio of the modified polyamide is 1.8 or greater.

23. The flame retardant polyamide of claim 1, wherein the composition exhibits a glow wire ignition temperature (GWIT) of 775° C. or greater.

24. The flame retardant polyamide of claim 1, wherein the composition exhibits a comparative tracking index of 300V or greater.

25. A flame retardant polyamide composition comprising:
from 50 wt % to 75 wt % of a polyamide;
from 13 wt % to 15 wt % of an epoxy-terminated brominated epoxy polymer;
from 9 wt % to 11 wt % of a tribromophenol end-capped brominated epoxy polymer; and
from 1 wt % to 5 wt % of two or more plasticizers;
wherein the composition is free of a decabromodiphenyl ethane (DBDPE) flame retardant,
wherein the polyamide composition demonstrates an elongation of break of at least 9.5%, and
wherein the polyamide composition demonstrates a UL-94 rating of V-0 or better.

26. The flame retardant polyamide composition of claim 25, wherein one of the plasticizers is diundecyl phthalate and one of plasticizers is triethylene glycol bis(2-ethylhexanoate).
